(19) United States
(12) Patent Application Publication
(10) Pub. No.: US 2009/0023047 A1
(43) Pub. Date: Jan. 22, 2009

(54) FUEL CELL

(76) Inventor: Hideaki Kume, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/162,996

(22) PCT Filed: Feb. 1, 2007
(86) PCT No.: PCT/IB2007/000241

§ 371 Date: Aug. 1, 2008

(30) Foreign Application Priority Data
Feb. 2, 2006 (JP) 2006-025225

(51) Int. Cl. H01M 8/02

(52) U.S. Cl. 429/35

(57) ABSTRACT

A fuel cell which does not discharge fuel gas supplied to an anode (22) thereof to the outside at least during normal power generation having a gas diffusion layer (15) of a conductive porous material stacked on the anode (22) and having fuel gas flow passages therein through which fuel gas is supplied to the anode (22); a sealing part (16) disposed around the gas diffusion layer for preventing leakage of the fuel gas to the outside of a single cell (10); a gas supply part (52) for supplying the fuel gas; and a first fuel gas supply flow passage formed by a gap between at least a part of a periphery of the gas diffusion layer (15) and the sealing part (16) for supplying the fuel gas supplied from the gas supply part (52) to the gas diffusion layer (15).

### BACKGROUND OF THE INVENTION

1. Field of the Invention

This invention relates to a fuel cell, and, more particularly, to a fuel cell which does not discharge fuel gas supplied to anodes thereof to the outside at least during normal power generation.

2. Description of the Related Art

In recent years, fuel cells, which generate electricity through an electrochemical reaction between hydrogen and oxygen, are attracting attention as energy sources. A fuel cell disclosed in Japanese Patent Application Publication No. JP-A-10-121284 has an electrolyte membrane, an anode provided on the electrolyte membrane, and a gas diffusion layer provided on the anode. The gas diffusion layer is made of, for example, a conductive porous material to form fuel gas flow passages through which fuel gas containing hydrogen supplied from a predetermined manifold is supplied to and discharged from the anode and to ensure gas diffusibility or current collectivity. The manifold is hereinafter referred to also as “fuel gas supply manifold”. Also, the fuel cell has a cathode on the side of the electrolyte membrane opposite the side on which the anode is provided.

A fuel cell which does not discharge fuel gas supplied to the anode thereof to the outside at least during normal power generation, that is, an anode dead-end operation fuel cell, is disclosed (for example, Japanese Patent Application Publication No. JP-A-9-312167). In such an anode dead-end operation fuel cell, when fuel gas is supplied from the fuel gas supply manifold into the gas diffusion layer, the fuel gas is supplied from a specific position of the gas diffusion layer such that the fuel gas can be spread into the entire gas diffusion layer. In this case, the point from which the fuel gas is supplied into the gas diffusion layer is hereinafter referred to also as “gas supply point.”

In a fuel cell, water is generated at the cathode through an electrochemical reaction between fuel gas and oxidant gas containing oxygen during power generation. The generated water may leak to the anode side through the electrolyte membrane. Also, when air is used as the oxidant gas, nitrogen and so on in the air may leak from the cathode side to the anode side. For the anode, the generated water, nitrogen and so on are impurities which inhibit the generation of electricity.

In an anode dead-end operation fuel cell, fuel gas is supplied from a gas supply point to every part of the gas diffusion layer as described above. At this time, the fuel gas is spread radially from the gas supply point into the gas diffusion layer, and impurities such as generated water and nitrogen are transported to parts of the gas diffusion layer far from the gas supply point by the flow of the fuel gas. In this case, since the fuel gas flows long distances in the flow passages between the gas supply point and parts far from the gas supply point in gas diffusion layer (which are hereinafter referred to also as “long-distance flow passages”), a large amount of fuel gas is consumed. Thus, a large amount of fuel gas is newly supplied into the long-distance flow passages from the gas supply point. Therefore, fuel gas is swiftly supplied from the gas supply point into the long-distance flow passages. Since the flow velocity of the fuel gas newly supplied into the long-distance flow passages is high, the impurities transported to parts of the gas diffusion layer far from the gas supply point cannot spread against the flow of the fuel gas and is confined in the parts. Then, the supply of fuel gas to the parts of the gas diffusion layer decreases and power generation in the parts decreases, resulting in degradation in the power generation performance of the entire fuel cell.

### SUMMARY OF THE INVENTION

The present invention provides an art of preventing accumulation of impurities in a fuel gas flow passage body of an anode dead-end operation fuel cell to prevent degradation in power generation performance of the fuel cell.

A fuel cell as an aspect of the present invention is a fuel cell which does not discharge fuel gas supplied to an anode thereof to the outside at least during normal power generation, and is characterized by including: a fuel gas flow passage body stacked on the anode for supplying the fuel gas to the anode; a sealing part disposed around the fuel gas flow passage body for preventing leakage of the fuel gas to the outside of single cells; a gas supply part for supplying the fuel gas; and a first fuel gas supply flow passage, defined by a gap between at least a part of a periphery of the fuel gas flow passage body and the sealing part, through which the fuel gas supplied from the gas supply part is supplied to the fuel gas flow passage body.

According to the fuel cell constituted as described above, the fuel gas supplied from the gas supply part flows along the first fuel gas supply flow passage and flows into the fuel gas flow passage body from the first fuel gas supply flow passage. Therefore, the lengths of the fuel gas flow passages in the fuel gas flow passage body may be short. Thus, in the fuel gas flow passage body, the flow velocity of the fuel gas can be lowered to prevent a large amount of impurities from accumulating in specific positions. As a result, inhibition of power generation at the positions can be prevented and degradation in power generation performance of the entire fuel cell can be prevented.

In the above fuel cell, the fuel gas flow passage body may be a gas diffusion layer made of a conductive porous material.

In the above fuel cell, the fuel gas flow passage body may be divided into a plurality of pieces. In this case, the fuel cell may have a second fuel gas supply flow passage, formed by a gap between adjacent pieces of the fuel gas flow passage body and communicated with the first fuel gas supply flow passage, through which the fuel gas supplied from the first gas supply flow passage is supplied to the gas diffusion layer.

In this configuration, the fuel gas supplied from the gas supply part flows along the first fuel gas supply flow passage and the second fuel gas supply flow passage and flows into the gas diffusion layer from the first and second fuel gas supply flow passages. Therefore, the lengths of the fuel gas flow passages in the gas diffusion layer may be shorter.

The above fuel cell may further include: a separator constituted of a first plate disposed outside the fuel gas flow passage body and opposed to and in contact with the fuel gas flow passage body; a second plate; and an intermediate plate interposed between the first and second plates, and having a fuel gas supply manifold, extending through the first and second plates and the intermediate plate in the thickness direction of the plates, through which the fuel gas flows. The first plate may have a pass-through port formed at a position corresponding to the first fuel gas supply flow passage and extending therethrough in the thickness direction. The intermediate plate may have a third fuel gas supply flow passage having a first end communicated with the fuel gas supply manifold and a second end communicated with the pass-through port and located between the first and second plates to form a flow passage through which the fuel gas is supplied from the fuel gas supply manifold to the pass-through port. The pass-through port may function as the gas supply part to supply the fuel gas in a direction generally perpendicular to the fuel gas flow passage body to the first fuel gas supply flow passage.

In this configuration, the pass-through port of the first plate in the separator functions as the gas supply part to supply the fuel gas to the first fuel gas supply flow passage.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is an explanatory view illustrating an external configuration of a fuel cell 100 according to a first embodiment of the present invention.

FIGS. 2A and 2B are explanatory views illustrating a general configuration of modules 200 constituting the fuel cell 100 as the first embodiment.

FIG. 3 is an explanatory view illustrating the configuration of an anode side plate 32.

FIG. 4 is an explanatory view illustrating the configuration of a cathode side plate 31.

FIG. 5 is an explanatory view illustrating the configuration of an intermediate plate 33.

FIG. 6 is a plan view illustrating a general cross-sectional configuration of a sealing part 16 and a second gas diffusion layer 15.

FIG. 7 is a plan view illustrating a general cross-sectional configuration of a sealing part 16 and a second gas diffusion layer 15a of a fuel cell 100a as a second embodiment of the present invention.

FIG. 8 is a plan view illustrating a general cross-sectional configuration of a sealing part 16 and a second gas diffusion layer 15b of a fuel cell 100b as a third embodiment of the present invention.

FIG. 9 is a plan view illustrating a general cross-sectional configuration of a sealing part 16 and a second gas diffusion layer 15c of a fuel cell 100c as a fourth embodiment of the present invention.

FIG. 10 is a plan view illustrating a general cross-sectional configuration of a sealing part 16 and a second gas diffusion layer 15d of a fuel cell 100d as a fifth embodiment of the present invention.

FIG. 11 is a plan view illustrating a general cross-sectional configuration of a sealing part 16 and a second gas diffusion layer 15e of a fuel cell 100e as a sixth embodiment of the present invention.

### DETAILED DESCRIPTION OF THE PREFERRED EMBODIMENTS

Description is hereinafter made of embodiments of the present invention based on specific examples.

### A. First Embodiment:

A1. Configuration of Fuel Cell 100:

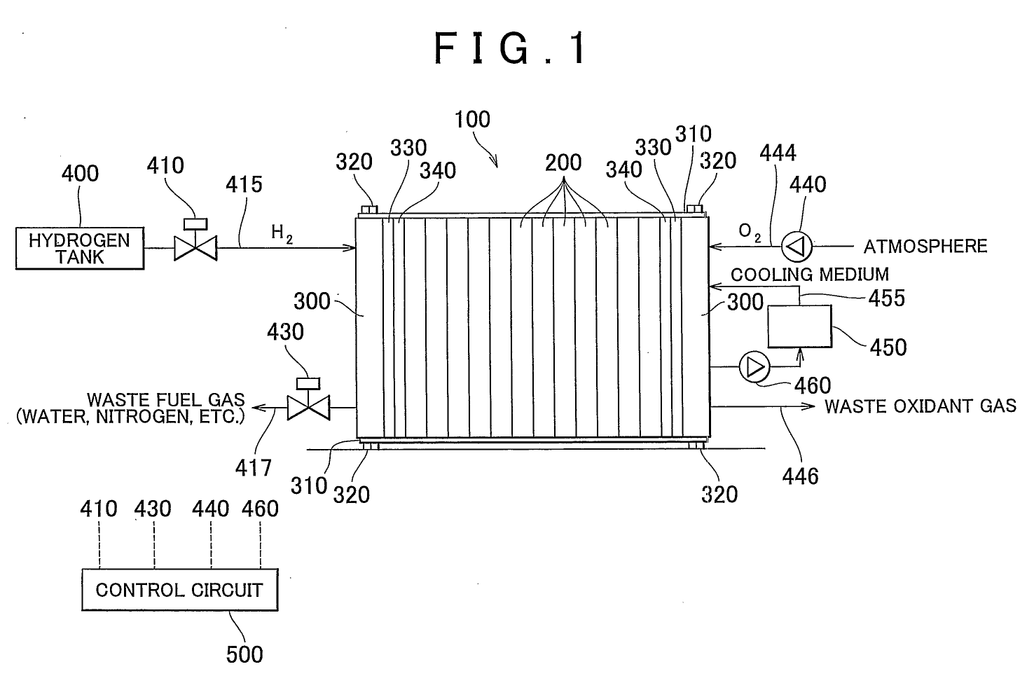

FIG. 1 is an explanatory view illustrating an external configuration of a fuel cell 100 according to a first embodiment of the present invention. The fuel cell 100 of this embodiment is a polymer electrolyte fuel cell, which is relatively small in size and excellent in power generation efficiency. The fuel cell 100 has modules 200, end plates 300, tension plates 310, insulators 330, and terminals 340. The modules 200 are supported between the two end plates 300 with the insulators 330 and the terminals 340 interposed therebetween. That is, the fuel cell 100 has a stack structure in which a plurality of modules 200 are stacked each other. Also, in the fuel cell 100, the tension plates 310 are secured to the end plates 300 by bolts 320 so that the modules 200 can be fastened in the stacking direction by a predetermined force.

The fuel cell 100 is supplied with reactant gases (fuel gas and oxidant gas) for an electrochemical reaction and a cooling medium (such as water, antifreeze solution such as ethylene glycol, and air) for cooling the fuel cell 100. Hydrogen as fuel gas is supplied from a hydrogen tank 400 for storing high-pressure hydrogen to anodes of the fuel cell 100 through a pipe 415. Hydrogen may be generated through a reforming reaction which uses alcohol, hydrocarbon or the like as a reactant instead of supplying from the hydrogen tank 400. The pipe 415 is provided with a shut valve 410 and a pressure control valve (not shown) for controlling the supply of hydrogen. The fuel cell 100 also has a pipe 417, connected to a fuel gas discharge manifold, which is described later, through which impurities (generated water, nitrogen, etc.) are discharged from the anodes to the outside of the fuel cell 100 together with fuel gas. The pipe 417 is provided with a shut valve 430. The shut valve 430 is usually controlled to be kept closed while the fuel cell 100 is generating electricity by a control circuit 500, which is described later, so that fuel gas and so on cannot be discharged through the pipe 417 during normal power generation. As described above, the fuel cell 100 is what they call an anode dead-end operation fuel cell, which does not discharge fuel gas to the outside at least during normal power generation. The shut valve 430 is sometimes opened during power generation in order to remove impurities accumulated on the anode side (second gas diffusion layers 15, which are described later). This is not included in the “during normal power generation.”

Air as oxidant gas is supplied to cathodes of the fuel cell 100 from an air pump 440 through a pipe 444. Air discharged from the cathodes of the fuel cell 100 is discharged into the atmosphere through a pipe 446. A cooling medium is also supplied to the fuel cell 100 from a radiator 450 through a pipe 455. As the cooling medium, water, antifreeze solution such as ethylene glycol, air or the like can be used. Cooling medium discharged from the fuel cell 100 is fed to the radiator 450 through a pipe 455 and recirculated in the fuel cell 100. The pipe 455 is provided with a circulation pump 460 for circulation.

The control circuit 500 is constituted as a logic circuit including mainly a microcomputer. More specifically, the control circuit 500 has a CPU (not shown) for executing a predetermined operation and so on according to a preset control program; a ROM (not shown) for storing in advance a control program, control data and so on necessary for various processing operations in the CPU; a RAM (not shown) for temporarily storing various data necessary for the processing operations in the CPU; an input-output port (not shown) for inputting and outputting various signals, and so on, and performs various controls on the shut valve 410, the shut valve 430, the air pump 440, the circulation pump 460 and so on while the fuel cell 100 is generating electricity. Especially, in the fuel cell 100 of this embodiment, the control circuit 500 perform control to keep the shut valve 430 closed during power generation. Also, the control circuit 500 performs control to open the shut valve 430 as needed when electricity is not generated in order to discharge impurities accumulated on the anode side (second gas diffusion layers 15, which are described later) together with fuel gas.

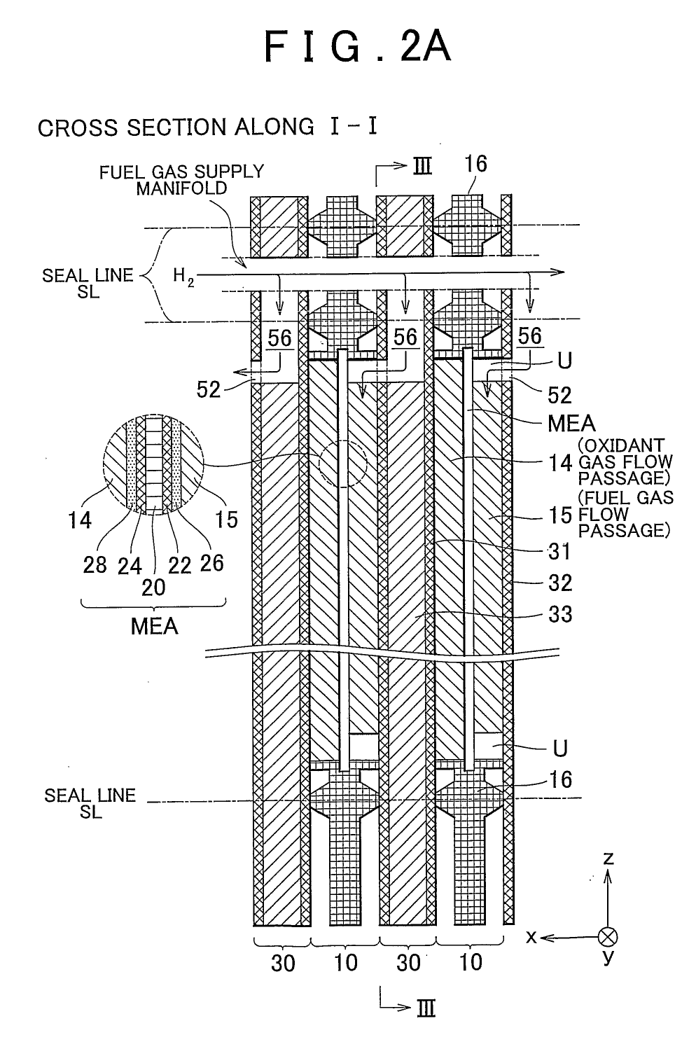

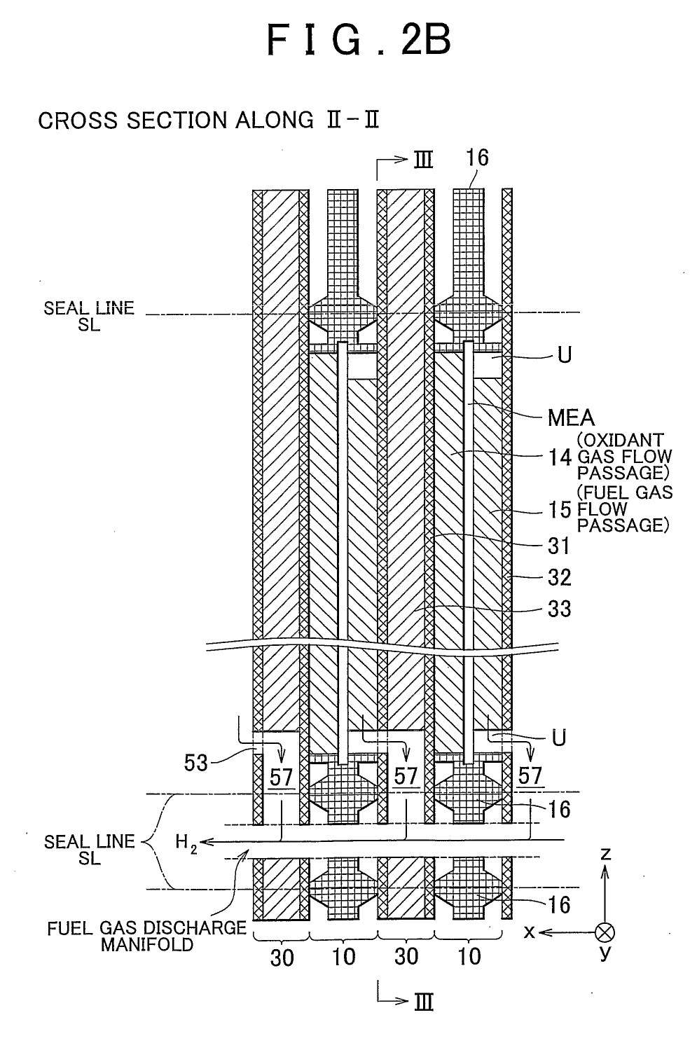

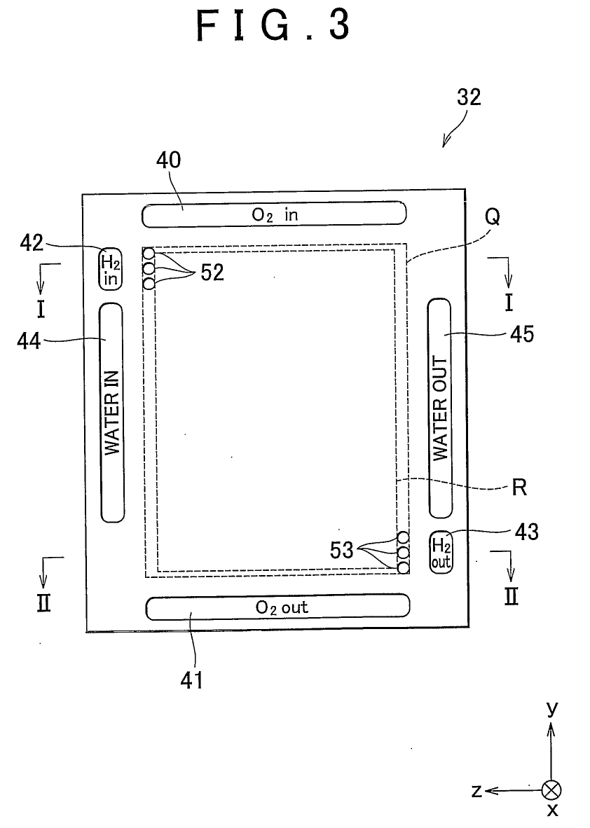

FIG. 2 is an explanatory view illustrating a general configuration of modules 200 constituting the fuel cell 100 as the first embodiment. FIG. 2A illustrates a cross-sectional configuration of the fuel cell 100 (modules 200), taken along the line I-I of FIG. 3 to FIG. 6. FIG. 2B illustrates a cross-sectional configuration of the fuel cell 100 (modules 200), taken along the line II-II of FIG. 3 to FIG. 6. The modules 200 are formed by stacking separators 30 and single cells 10 alternately as shown in FIG. 2. In the following, the direction in which the separators 30 and the single cells 10 are stacked is referred to as “stacking direction,” and the direction parallel to surfaces of the single cells 10 is referred to as “surface direction.”

### A2. Configuration of Separator 30:

The separator 30 used in the fuel cell 100 of this embodiment is first described. The separator 30 is what they call a three-layer separator having three plates with the same external shape as viewed in the stacking direction. As shown in FIG. 2, the separator 30 has a cathode side plate 31 in contact with a second gas diffusion layer 14, an anode side plate 32 in contact with a second gas diffusion layer 15, and an intermediate plate 33 interposed between the cathode side plate 31 and the anode side plate 32. The three plates, which are thin plate members made of a conductive material, e.g. a metal such as titanium (Ti), are stacked as shown in FIG. 2 and joined together by, for example, diffusion bonding. The three plates all have flat surfaces free of irregularities and openings with predetermined shapes at predetermined positions.

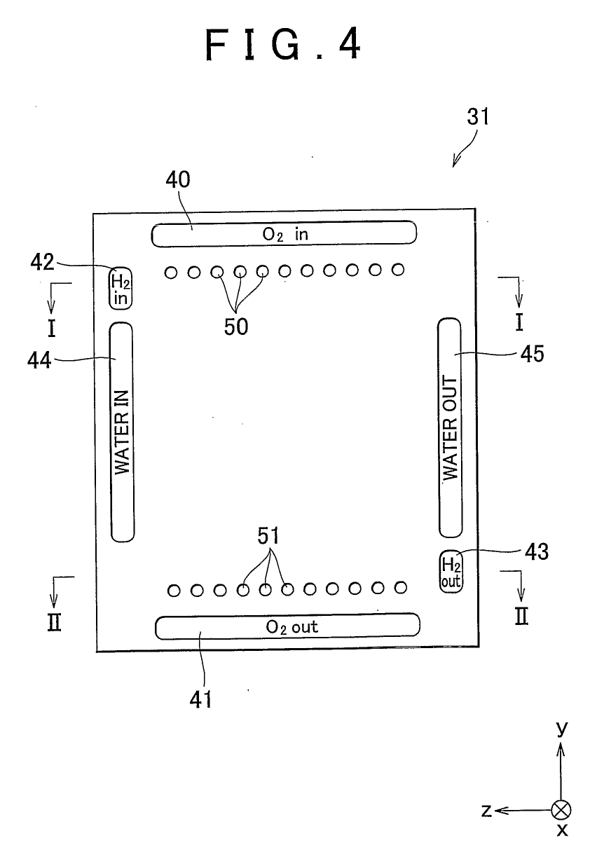

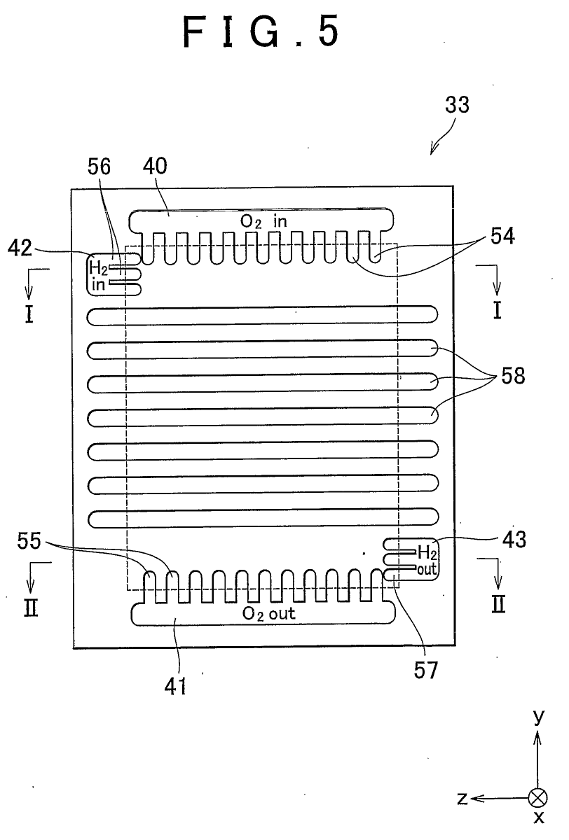

FIG. 3 is an explanatory view illustrating the configuration of an anode side plate 32. FIG. 4 is an explanatory view illustrating the configuration of a cathode side plate 31. FIG. 5 is an explanatory view illustrating the configuration of an intermediate plate 33. The anode side plate 32 (FIG. 3) and the cathode side plate 31 (FIG. 4) have six openings at the same positions. The six openings respectively overlap each other to define manifolds for directing fluids in a direction parallel to the stacking direction in the fuel cell when the thin plate members are stacked to form a module 200.

Openings 42 define a fuel gas supply manifold (indicated as “H₂ in” in the drawings) for distributing fuel gas supplied to the fuel cell 100 to each single cell 10, and openings 43 define a fuel gas discharge manifold (indicated as “H₂ out” in the drawings). As described before, the fuel cell 100 is an anode dead-end operation fuel cell. The shut valve 430 is kept closed, and fuel gas and so on are not discharged from the fuel gas discharge manifold formed by the openings 43 during power generation. When the shut valve 430 is opened while electricity is not generated, impurities are discharged from each single cell 10 together with fuel gas and directed to the outside through the fuel gas discharge manifold formed by the openings 43.

Openings 40 define an oxidant gas supply manifold (indicated as “O₂ in” in the drawings) for distributing oxidant gas supplied to the fuel cell 100 to each single cell 10, and openings 41 define an oxidant gas discharge manifold (indicated as “O₂ out” in the drawings) for directing waste oxidant gas discharged from each single cell 10 and collected together to the outside.

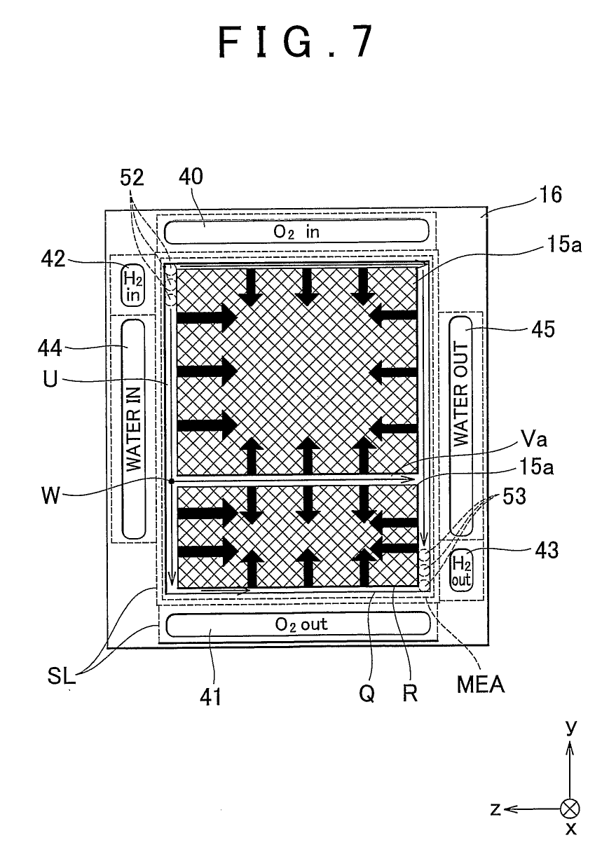

Openings 44 define a cooling medium supply manifold (indicated as “water in” in the drawings) for distributing cooling medium supplied to the fuel cell 100 into each separator 30, and openings 45 define a cooling medium discharge manifold (indicated as “water out”) for directing cooling medium discharged from each separator 30 and collected together to the outside. The intermediate plate 33 (FIG. 7) has openings 40, 41, 42 and 43 of the above described openings, and has a plurality of cooling medium holes 58, which are described later, at positions corresponding to the openings 44 and 45.

As shown in FIG. 3, the anode side plate 32 has communication holes 52 in the vicinity of the opening 42 as a plurality of openings arranged along the opening 42, and a plurality of communication holes 53 in the vicinity of the opening 43 arranged along the opening 43. As shown in FIG. 4, the cathode side plate 31 has communication holes 50 in the vicinity of the opening 50 as a plurality of openings arranged along the opening 40, and a plurality of communication holes 51 in the vicinity of the opening 41 arranged along the opening 41. As shown in FIG. 5, the shape of the openings 42 and 43 of the intermediate plate 33 is different from that of the other plates, and the openings 42 and 43 have communicating parts 56 and 57, respectively, as a plurality of extended parts extended therefrom. The communicating parts 56 and 57 are formed at positions corresponding to the communication holes 52 and 53, respectively so that the communicating parts 56 and 57 overlap the communication holes 52 and 53, respectively, to communicate the fuel gas supply manifold with the communication holes 52 and the fuel gas discharge manifold with the communication holes 53 when the intermediate plate 33 is stacked on the anode side plate 32. The openings 40 and 41 of the intermediate plate 33 also have a plurality of communicating parts 54 and 55, respectively, corresponding to the communication holes 50 and 51.

### A3. Configuration of Single Cell 10:

As shown in FIG. 2, the single cell 10 has a membrane-electrode assembly (MEA), second gas diffusion layers 14 and 15 disposed outside the MEA, and a sealing part 16. The MEA has an electrolyte membrane 20, an anode 22 and a cathode 24 as catalyst electrodes formed on the surfaces of the electrolyte membrane 20 with the electrolyte membrane 20 therebetween, and first gas diffusion layers 26 and 28 disposed outside the catalyst electrodes.

The electrolyte membrane 20 is an ion exchange membrane with proton conductivity made of a polymer material such as a fluororesin containing, for example, a perfluorocarbon sulfonic acid, and has excellent electrical conductivity in wet conditions. The anode 22 and the cathode 24 have a catalyst which promotes an electrochemical reaction, such as platinum or an alloy of platinum and other metals. The first gas diffusion layers 26 and 28 are porous members made of, for example, carbon.

The second gas diffusion layers 14 and 15 are made of a metal porous material such as foam metal or metal mesh of titanium (Ti), for example. The second gas diffusion layers 14 and 15 are disposed to fill the entire space between the MEA and adjacent separators 30, and the spaces formed by a multiplicity of small cavities therein function as inter-single-cell gas flow passages through which the gas (reactant gas, that is, fuel gas or oxidant gas) for the electrochemical reaction flows. In this case, the inter-single-cell gas flow passages formed in the second gas diffusion layer 15 are referred to also as “fuel gas flow passages,” and the inter-single-cell gas flow passages formed in the second gas diffusion layer 14 are referred to also as “oxidant gas flow passages.”

The fuel gas flow passage body may be made of a wavy flow passage or an expand metal, not of a metal porous material.

The sealing part 16 is disposed between adjacent separators 30 and around the MEA and the second gas diffusion layers 14 and 15. The sealing part 16 is made of an insulating rubber material such as silicone rubber, butyl rubber or fluoro-rubber, and formed integrally with the MEA. The sealing part 16 can be formed by, for example, placing the MEA in a cavity of a mold and injection-molding the above resin material into the mold. Then, the resin material is impregnated into the first gas diffusion layers of a porous material and joins the MEA and the sealing part 16 closely together to form a gas tight seal on both sides of the MEA. The sealing part 16 also functions as a supporting part for supporting the electrolyte membrane 20 having catalyst electrodes.

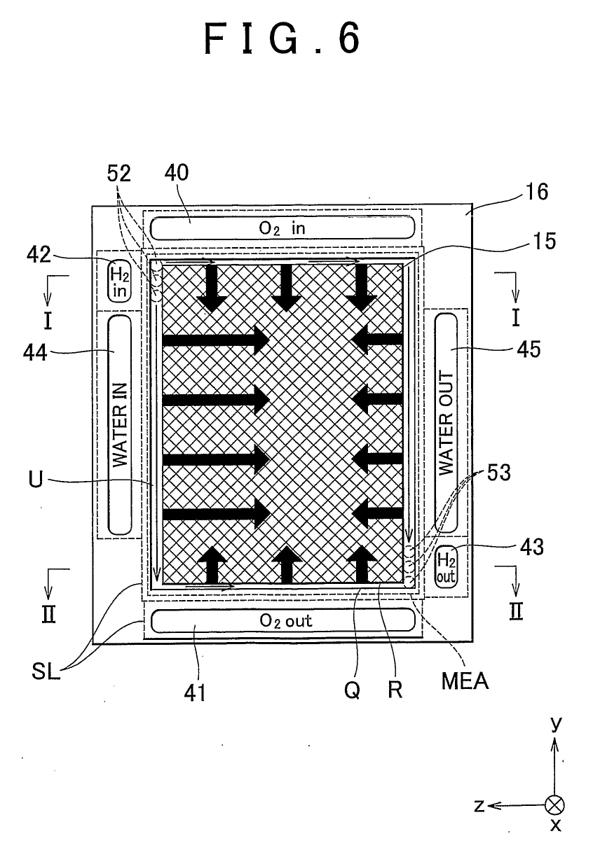

FIG. 6 is a plan view illustrating a general cross-sectional configuration of a sealing part 16 and a second gas diffusion layer 15. FIG. 6 illustrates a cross-sectional configuration of the single cell 10, taken along the line III-III of FIGS. 2A and 2B. As shown in FIG. 6, the sealing part 16 is a thin plate-like member with a generally rectangular shape, and has six openings formed through its outer periphery and a generally rectangular opening (cross-hatched part) formed at its center, in which the MEA and the second gas diffusion layers 14 and 15 are fitted. Although not shown in the plan view of FIG. 6, the sealing part 16 has predetermined projections and depressions in reality as shown in FIGS. 2A and 2B, and the projections surrounding the above six openings and the generally rectangular opening are in contact with adjacent separators 30 in the fuel cell 100. The positions where the sealing parts 16 and the separators 30 are in contact with each other (indicated by dot-and-dash lines in FIGS. 2A and 2B) are shown as seal lines SL in the plan view of FIG. 6. Since the sealing part 16 is made of an elastic resin material, a pressure in a direction parallel to the stacking direction is applied in the fuel cell 100 to form a gas tight seal along the seal lines SL.

### A4. Flow of Fuel Gas:

Here, a line along the inner edge of the sealing part 16 is referred to as “sealing part inner edge line Q,” and a line along the outer periphery of the second gas diffusion layer 15 is referred to as “gas diffusion layer outer peripheral line R” as shown in FIG. 6. In the fuel cell 100 of this embodiment, a gap U is formed between the gas diffusion layer outer peripheral line R and the sealing part inner edge line Q. When the single cell 10 and the separator 30 are stacked, the communication holes 52 of the anode side plate 32 described before face the gap U (see FIG. 6). In this case, the part of the gap U facing the communication holes 52 has a width generally equal to the diameter of the communication holes 52. Thus, the fuel gas from the communication holes 52 first flows into the gap U.

In the fuel cell 100 (modules 200), the fuel gas flowing through the fuel gas supply manifold formed by the openings 42 of the plates flows in the stacking direction into the gap U through spaces formed by the communicating parts 56 of the intermediate plate 33 and the communication holes 52 of the anode side plate 32 as shown in FIGS. 2A and 2B. The fuel gas having flown into the gap U flows in the gap U along the gas diffusion layer outer peripheral line R and then flows from the gas diffusion layer outer peripheral line R into the second gas diffusion layer 15 as shown in FIG. 6. Therefore, the fuel gas flow passages in the second gas diffusion layer 15 may be short since the fuel gas flow passages do not have to extend across the second gas diffusion layer 15. Thus, in the second gas diffusion layer 15, the flow velocity of the fuel gas can be lowered to prevent a large amount of impurities from accumulating in specific positions. As a result, inhibition of power generation at the positions can be prevented and degradation in power generation performance of the entire fuel cell 100 can be prevented.

In the fuel gas flow passages in the second gas diffusion layer 15, the fuel gas flows in the surface direction and is diffused in the stacking direction. Then, the fuel gas reaches the anode 22 through the first gas diffusion layer 26, and is used in the electrochemical reaction. When the shut valve 430 is opened by the control circuit 500 while the fuel cell 100 is not generating electricity, the fuel gas in the second gas diffusion layer 15 is discharged, together with impurities, into the fuel gas discharge manifold formed by the openings 43 through the communication holes 53 of the anode side plate 32 and the spaces formed by the communicating parts 57 of the intermediate plate 33.

In the fuel cell 100 (modules 200), the oxidant gas flowing through the oxidant gas supply manifold formed by the openings 40 of the plates flows into the oxidant gas flow passages in the second gas diffusion layer 14 through the spaces formed by the communicating parts 54 of the intermediate plate 33 and the communication holes 50 of the cathode side plate 31, flows in the surface direction, and is further diffused in the stacking direction. The oxidant gas diffused in the stacking direction reaches from the second gas diffusion layer 14 to the cathode 24 through the first gas diffusion layer 28 and is used in the electrochemical reaction. The oxidant gas having contributed to the electrochemical reaction and passed through the oxidant gas flow passages as described above is discharged from the second gas diffusion layer 14 into the oxidant gas discharge manifold formed by the openings 41 through the communication holes 51 of the cathode side plate 31 and the spaces formed by the communicating parts 55 of the intermediate plate 33.

The intermediate plate 33 has a plurality of elongated cooling medium holes 58 formed parallel to each other. When the cathode side plate 31 and the anode side plate 32 are stacked on the intermediate plate 33, the both ends of the cooling medium holes 58 overlap the openings 44 and 45 to form inter-single-cell cooling medium flow passages through which the cooling medium flows in the separator 30. That is, in the fuel cell 100, the cooling medium flowing through the cooling medium supply manifold formed by the openings 44 is distributed into the inter-single-cell cooling medium flow passages formed by the cooling medium holes 58, and the cooling medium discharged from the inter-single-cell cooling medium flow passages is discharged into the cooling medium discharge manifold formed by the openings 45.

The second gas diffusion layer 15 may be regarded as a fuel gas flow passage body. The communication holes 52 may be regarded as a pass-through port and a gas supply part. The gap U may be regarded as a first fuel gas supply flow passage. The anode side plate 32 and the cathode side plate 31 may be regarded as a first plate and a second plate, respectively. The communicating parts 56 may be regarded as a third fuel gas supply flow passage.

### B. Second Embodiment:

FIG. 7 is a plan view illustrating a general cross-sectional configuration of a sealing part 16 and a second gas diffusion layer 15a of a fuel cell 100a as a second embodiment of the present invention. The second embodiment is different from the first embodiment shown in FIG. 6 in that the second gas diffusion layer 15a in the fuel cell 100a of the second embodiment is divided into two pieces in the longitudinal direction of the second gas diffusion layer 15a (y direction in FIG. 7) and a gap Va is formed between the two pieces as shown in FIG. 7. In this case, the fuel gas having flown into the gap U through the communication holes 52 of the anode side plate 32 flows in the gap U along the gas diffusion layer outer peripheral line R and also flows into the gap Va from a branching point W. Therefore, fuel gas flows from the gas diffusion layer outer peripheral line R and the gap Va into the second gas diffusion layer 15a. In this configuration, the fuel gas flow passages in the second gas diffusion layer 15a can be shorter than those in the first embodiment. Thus, in the second gas diffusion layer 15a, the flow velocity of the fuel gas can be lowered to prevent a large amount of impurities from accumulating in specific positions. As a result, inhibition of power generation at the positions can be prevented and degradation in power generation performance of the entire fuel cell 100a can be prevented. Although the second gas diffusion layer 15a is divided into two pieces in the longitudinal direction in the above example, the present invention is not limited thereto. The second gas diffusion layer 15a may be divided into three or more pieces in the longitudinal direction and gaps Va may be formed between the pieces. With this configuration, the same effect as above can be achieved.

In the gap U, the flow of the fuel gas is stronger in a part closer to the communication holes 52, through which the fuel gas flows into the gap U. Also, as the flow of the fuel gas in the gap U is stronger, the fuel gas can penetrate into the second gas diffusion layer 15a more easily. Therefore, the fuel gas flowing in the gap U can penetrate into the second gas diffusion layer 15a in a part closer to the communication holes 52 more easily. The second gas diffusion layer 15a of the fuel cell 100a in this embodiment is divided into two pieces, and the gap Va is formed such that the piece of the second gas diffusion layer 15a closer to the communication holes 52, through which fuel gas flows into the second gas diffusion layer 15a, of the pieces of the second gas diffusion layers 15a has a larger area than the piece of the second gas diffusion layer 15a farther from the communication holes 52 as shown in FIG. 7. In this configuration, the fuel gas can easily penetrate deep into the piece of the second gas diffusion layer 15a farther from the communication holes 52 of the pieces of the second gas diffusion layers 15a.

### C. Third Embodiment:

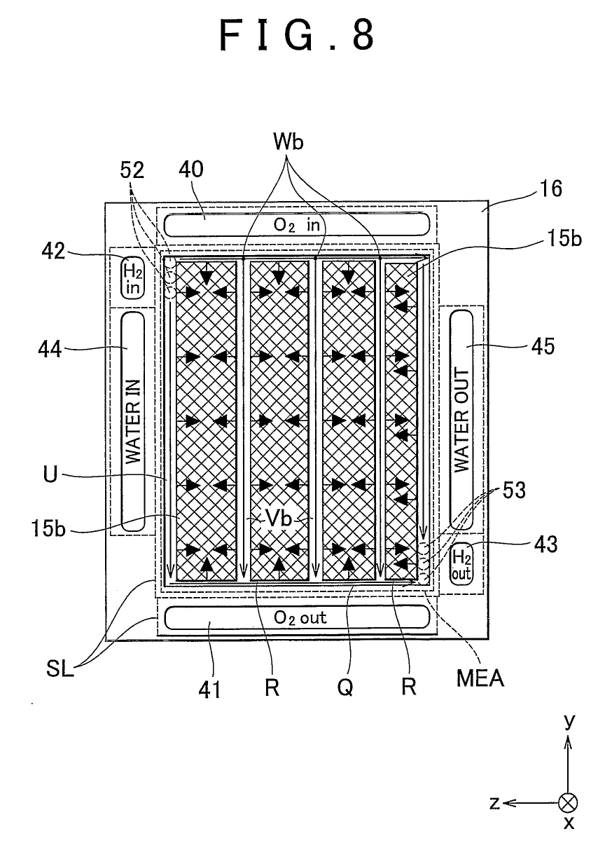

FIG. 8 is a plan view illustrating a general cross-sectional configuration of a sealing part 16 and a second gas diffusion layer 15b of a fuel cell 100b as a third embodiment of the present invention. The third embodiment is different from the first embodiment shown in FIG. 6 in that the second gas diffusion layer 15b in the fuel cell 100b of the third embodiment is divided into four pieces in a z-direction, perpendicular to the longitudinal direction (y direction), and gaps Vb are formed between the four pieces as shown in FIG. 8.

In this case, the fuel gas having flown into the gap U through the communication holes 52 of the anode side plate 32 flows in the gap U along the gas diffusion layer outer peripheral line R and also flows into the gaps Vb from branching points Wb. Therefore, fuel gas flows into the second gas diffusion layer 15b from the gas diffusion layer outer peripheral line R and the gaps Vb. In this configuration, the fuel gas flow passages in the second gas diffusion layer 15b can be shorter than those in the first embodiment. Thus, in the second gas diffusion layer 15b, the flow velocity of the fuel gas can be lowered to prevent a large amount of impurities from accumulating in specific positions. As a result, inhibition of power generation at the positions can be prevented and degradation in power generation performance of the entire fuel cell 100b can be prevented.

Although the second gas diffusion layer 15b is divided into four pieces in the z-direction in the above example, the present invention is not limited thereto. The second gas diffusion layer 15b may be divided into a number other than four pieces in the z-direction and gaps Vb may be formed between the pieces. With this configuration, the same effect as above can be achieved.

### D. Fourth Embodiment:

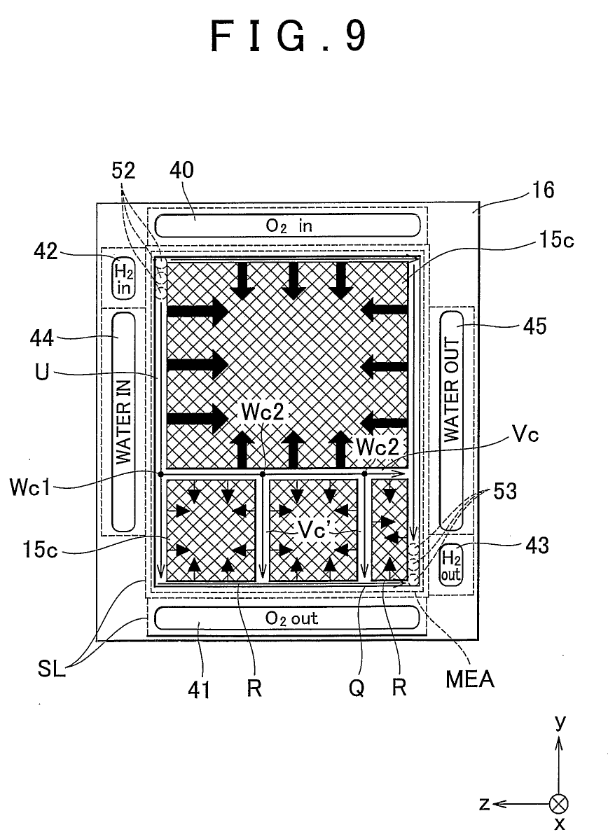

FIG. 9 is a plan view illustrating a general cross-sectional configuration of a sealing part 16 and a second gas diffusion layer 15c of a fuel cell 100c as a fourth embodiment of the present invention. The fourth embodiment is different from the first embodiment shown in FIG. 6 in that the second gas diffusion layer 15c in the fuel cell 100c of the fourth embodiment is divided into two pieces in the longitudinal direction (y-direction) and a gap Vc is formed between the two pieces and in that the piece of the second gas diffusion layer 15c farther from the communication holes 52, through which the fuel gas flows into the second gas diffusion layer 15c, in the pieces of the second gas diffusion layer 15c is divided into three pieces and gaps Vc′ are formed between the pieces as shown in FIG. 9.

In this case, the fuel gas having flown into the gap U through the communication holes 52 of the anode side plate 32 flows in the gap U along the gas diffusion layer outer peripheral line R and also flows into the gap Vc from a branching point Wc1 and into the gaps Vc′ from the gap Vc via branching points Wc2. Therefore, fuel gas flows into the second gas diffusion layer 15c from the gas diffusion layer outer peripheral line R, the gap Vc and the gaps Vc′. In this configuration, the fuel gas flow passages in the second gas diffusion layer 15c can be shorter than those in the first embodiment. Thus, in the second gas diffusion layer 15c, the flow velocity of the fuel gas can be lowered to prevent a large amount of impurities from accumulating in specific positions. As a result, inhibition of power generation at the positions can be prevented and degradation in power generation performance of the entire fuel cell 100c can be prevented.

Although the second gas diffusion layer 15c is divided into two pieces in the longitudinal direction in the above example, the present invention is not limited thereto. The second gas diffusion layer 15c may be divided into a plurality of pieces in the longitudinal direction and gaps Vc may be formed between the pieces. Also, at least one of the pieces of the second gas diffusion layer 15c may be divided into a plurality of pieces in a z-direction, perpendicular to the longitudinal direction, and gaps Vc′ may be formed between the pieces. With this configuration, the same effect as above can be achieved.

### E. Fifth Embodiment:

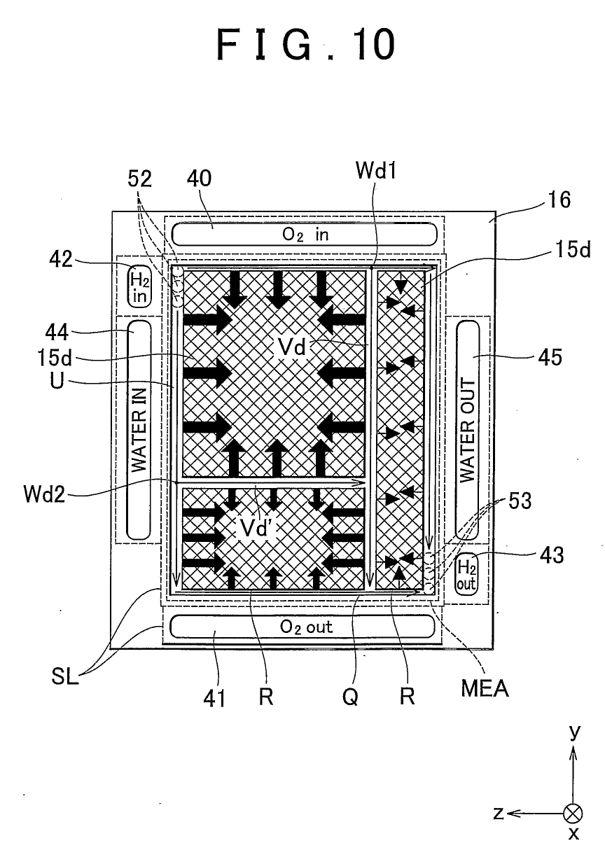

FIG. 10 is a plan view illustrating a general cross-sectional configuration of a sealing part 16 and a second gas diffusion layer 15d of a fuel cell 100d as a fifth embodiment of the present invention. The fifth embodiment is different from the first embodiment shown in FIG. 6 in that the second gas diffusion layer 15d in the fuel cell 100d of the fifth embodiment is divided into two pieces in a z-direction, perpendicular to the longitudinal direction, and a gap Vd is formed between the two pieces and in that the piece of the second gas diffusion layer 15d closer to the communication holes 52, through which the fuel gas flows into the second gas diffusion layer 15d, in the pieces of the second gas diffusion layer 15d is divided into two pieces as shown FIG. 10.

In this case, the fuel gas flowing into the gap U through the communication holes 52 of the anode side plate 32 flows in the gap U along the gas diffusion layer outer peripheral line R and also flows into the gap Vd from a branching point Wd1 and into a gap Vd′ from a branching point Wd2. Therefore, fuel gas flows into the second gas diffusion layer 15d from the gas diffusion layer outer peripheral line R, the gap Vd and the gap Vd′. In this configuration, the fuel gas flow passages in the second gas diffusion layer 15d can be shorter than those in the first embodiment. Thus, in the second gas diffusion layer 15d, the flow velocity of the fuel gas can be lowered to prevent a large amount of impurities from accumulating in specific positions. As a result, inhibition of power generation at the positions can be prevented and degradation in power generation performance of the entire fuel cell 100d can be prevented.

Although the second gas diffusion layer 15d is divided into two pieces in a z-direction, perpendicular to the longitudinal direction, in the above example, the present invention is not limited thereto. The second gas diffusion layer 15d may be divided into a plurality of pieces in a z-direction, perpendicular to the longitudinal direction, and gaps Vd may be formed between the pieces. Also, at least one of the pieces of the second gas diffusion layer 15d may be divided into a plurality of pieces in the longitudinal direction and gaps Vd′ may be formed between the pieces. With this configuration, the same effect as above can be achieved.

### F. Sixth Embodiment:

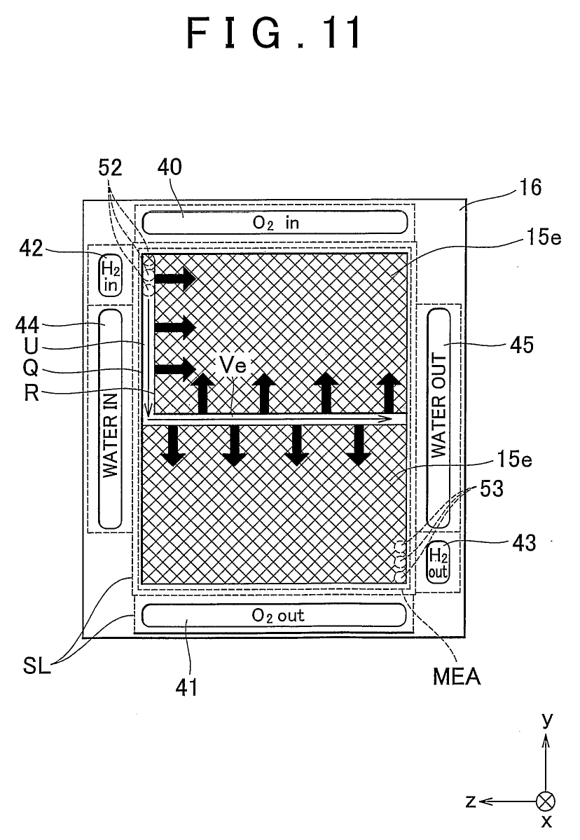

FIG. 11 is a plan view illustrating a general cross-sectional configuration of a sealing part 16 and a second gas diffusion layer 15e of a fuel cell 100e as a sixth embodiment of the present invention. The sixth embodiment is different from the first embodiment shown in FIG. 6 in that the gap U is formed only in a part corresponding to a part of the gas diffusion layer outer peripheral line R in the sixth embodiment, and in that the second gas diffusion layer 15e in the fuel cell 100e of the sixth embodiment is divided into two pieces in the longitudinal direction and a gap Ve communicated with the gap U is formed between the pieces as shown in FIG. 11.

In this embodiment, the fuel gas having flown into the gap U through the communication holes 52 of the anode side plate 32 flows in the gap U along the gas diffusion layer outer peripheral line R and flows into the gap Ve. Therefore, fuel gas flows into the second gas diffusion layer 15e from the gas diffusion layer outer peripheral line R and the gap Ve. In this configuration, since the fuel gas flows from the gap Ve into the second gas diffusion layer 15e, the fuel gas flow passages in the second gas diffusion layer 15e can be shorter than those in the fuel cell 100 of the first embodiment. Thus, in the second gas diffusion layer 15e, the flow velocity of the fuel gas can be lowered to prevent a large amount of impurities from accumulating in specific positions. As a result, inhibition of power generation at the positions can be prevented and degradation in power generation performance of the entire fuel cell 100e can be prevented.

The gaps Va, Vb, Vc, Vc′, Vd, Vd′ and Ve may be each regarded as a second fuel gas supply flow passage.

### G. Modifications:

The present invention is not limited to the above embodiments, and various modifications can be made without departing from the scope thereof.

### G1. Modification 1:

Although the shut valve 430 is kept closed during power generation and fuel gas is not discharged to the outside of the fuel cell 100 during power generation in the fuel cell of the above embodiments, the present invention is not limited thereto. For example, the openings 43 (that is, the fuel gas discharge manifold) may not be formed in fuel cell described above. In this case, high-concentrated oxygen as an oxidant may be supplied to the cathode 24 to solve the problem of leakage of nitrogen and so on from the cathode side to the anode side.

### G2. Modification 2:

Although the gap U is formed in a frame-like shape around the gas diffusion layer outer peripheral line R in the fuel cell in any one of the first to fifth embodiments, the present invention is not limited thereto. In the fuel cell, the gap U may be formed in a part corresponding to the communication holes 52 of the anode side plate 32 and along a part of the gas diffusion layer outer peripheral line R.

The present invention can be implemented in various forms other than the embodiments described above. For example, the present invention can be implemented in a form of a fuel cell system including the fuel cell of the present invention. In addition, the present invention is not limited to a device invention as described above and can be implemented in a form of a process invention such as a method for producing a fuel cell.

1. A fuel cell which does not discharge fuel gas supplied to an anode thereof to the outside at least during normal power generation, characterized by comprising:
a fuel gas flow passage body stacked on the anode for supplying the fuel gas to the anode;
a sealing part disposed around the fuel gas flow passage body for preventing leakage of the fuel gas to the outside of single cells;
a gas supply part for supplying the fuel gas; and
a first fuel gas supply flow passage, defined by a gap between at least a part of a periphery of the fuel gas flow passage body and the sealing part, through which the fuel gas supplied from the gas supply part is supplied to the fuel gas flow passage body.

2. The fuel cell according to claim 1,
wherein the fuel gas flow passage body is a gas diffusion layer made of a conductive porous material.

3. The fuel cell according to claim 1 or 2,
wherein the fuel gas flow passage body is divided into a plurality of pieces, and further comprising a second fuel gas supply flow passage, formed by at least one of the gaps between adjacent pieces of the fuel gas flow passage body and communicated with the first fuel gas supply flow passage, through which the fuel gas supplied from the first gas supply flow passage is supplied to the fuel gas flow passage body.

4. The fuel cell according to claim 3,
wherein the first fuel gas supply flow passage is formed between the entire periphery of the fuel gas flow passage body and the sealing part.

5. The fuel cell according to claim 4,
wherein the periphery of the fuel gas flow passage body has a rectangular shape.

6. The fuel cell according to claim 5,
wherein the fuel gas flow passage body is divided into a plurality of pieces along one side thereof and the gap for the second fuel gas supply flow passage is formed between adjacent pieces of the fuel gas flow passage body.

7. The fuel cell according to claim 6,
wherein a part of the fuel gas flow passage body farther from the gas supply part is divided into smaller pieces.

8. The fuel cell according to claim 6,
wherein a part of the fuel gas flow passage body farther from the gas supply part is divided into smaller pieces, and the gap for the second fuel gas supply flow passage between the pieces of the fuel gas flow passage body is arranged at a higher density in an area farther from the gas supply part.

9. The fuel cell according to claim 5,
wherein the fuel gas flow passage body is divided into two pieces in a longitudinal direction of the fuel gas flow passage body and the piece of the fuel gas flow passage body farther from a communication hole through which fuel gas flows into the fuel gas flow passage body is divided into a plurality of pieces, and the gap for the second fuel gas supply flow passage is formed between adjacent pieces of the fuel gas flow passage body.

10. The fuel cell according to claim 5,
wherein the fuel gas flow passage body is divided into two pieces in a direction perpendicular to a longitudinal direction of the fuel gas flow passage body and the piece of the fuel gas flow passage body nearer to a communication hole through which fuel gas flows into the fuel gas flow passage body is divided into a plurality of pieces, and the gap for the second fuel gas supply flow passage is formed between adjacent pieces of the fuel gas flow passage body.

11. The fuel cell according to claim 4 or 5,
wherein the fuel gas flow passage body is divided radially into a plurality of pieces, and the gap for the second fuel gas supply flow passage is formed between adjacent pieces of the fuel gas flow passage body.

12. The fuel cell according to claim 3,
wherein the gap for the first fuel gas supply flow passage is formed in a part corresponding to a part of a peripheral line of the fuel gas supply flow passage body, and the fuel gas supply flow passage body is divided into two pieces in a longitudinal direction of the fuel gas flow passage body and the gap for the second fuel gas supply flow passage is formed, in communication with the first fuel gas supply flow passage, between adjacent pieces of the fuel gas flow passage body.

13. A fuel cell without a mechanism for discharging fuel gas supplied to an anode thereof to the outside, characterized by comprising:
a fuel gas flow passage body stacked on the anode for supplying the fuel gas to the anode;
a sealing part disposed around the fuel gas flow passage body for preventing leakage of the fuel gas to the outside of single cells;
a gas supply part for supplying the fuel gas; and
a first fuel gas supply flow passage, defined by a gap between at least a part of a periphery of the fuel gas flow passage body and the sealing part, through which the fuel gas supplied from the gas supply part is supplied to the fuel gas flow passage body.

14. The fuel cell according to any one of claims 1 to 13,
further comprising a separator constituted of a first plate disposed outside the fuel gas flow passage body and opposed to and in contact with the fuel gas flow passage body; a second plate; and an intermediate plate interposed between the first and second plates, the separator having a fuel gas supply manifold, extending through the first and second plates and the intermediate plate in the thickness direction of the plates, through which the fuel gas flows,
wherein the first plate has a pass-through port formed at a position corresponding to the first fuel gas supply flow passage and extending therethrough in the thickness direction,
the intermediate plate has a third fuel gas supply flow passage having a first end communicated with the fuel gas supply manifold and a second end communicated with the pass-through port and located between the first and second plates to form a flow passage through which the fuel gas is supplied from the fuel gas supply manifold to the pass-through port; and
the pass-through port functions as the gas supply part to supply the fuel gas in a direction generally perpendicular to the fuel gas flow passage body to the first fuel gas supply flow passage.
